(19) United States
(12) Patent Application Publication
(10) Pub. No.: US 2001/0012813 A1
(43) Pub. Date: Aug. 9, 2001

(54) Process and apparatus for producing packaging bags, envelopes and the like

(76) Inventor: Martin Bluemle, Horhausen (DE)

Correspondence Address: FASSE PATENT ATTORNEYS, P.A., P.O. BOX 726, HAMPDEN, ME, 04444-0726, US

(21) Appl. No.: 09/767,369

(22) Filed: Jan. 22, 2001

(30) Foreign Application Priority Data
Jan. 21, 2000 (DE) 100 02 545.5

(51) Int. Cl. B31B 1/26

(52) U.S. Cl. 493/243

(57) ABSTRACT

The invention relates to a process and to an apparatus for producing packaging bags, envelopes and the like from web-like material, having a plurality of stations, including a side-folding station, in which the material is processed, which includes being cut to size, provided with preformed longitudinal and transverse creases and adhesive, folded and, finally, finished off, the drying of not yet set adhesive also being covered here.

The core of the invention is that, during the processing in at least one of the various stations, the web-like material is transported on a moving underlying surface and, at the same time, is retained on the underlying surface with the aid of negative pressure.

### DESCRIPTION

The invention relates to a process and to an apparatus for producing packaging bags, envelopes and the like from web-like material, the apparatus comprising a plurality of stations, including a side-folding station, in which the material is processed, which includes being cut to size, provided with preformed longitudinal and transverse creases, folded at least in part, provided with adhesive and, finally, finished off.

Processes and apparatuses of the type mentioned are known and are used extensively in the production of packaging bags or envelopes. The machines operate extremely quickly, with the result that large numbers can be produced per unit of time. However, difficulties often arise during transportation of the web-like materials in the apparatuses on account of tensile stressing if the web is weakened, for example, by shaped cuts and punching-out operations or loses tensile strength as a result of moisture during the application of adhesive. This loss of tensile strength has a disadvantageous effect both at high web speeds and, in particular, when the web is exposed to additionally increased tensile stressing. Such additional tensile stressing occurs, for example, during a reel change when a new material web, likewise located on a reel, has to be connected to a material web which has been used up. It is then necessary for the production speed to be reduced in order that the changeover from one material web to the next material web proceeds as far as possible without disruption.

The object of the invention is to provide measures in order for it to be possible for a material web to be guided as far as possible without tensile stressing through one or more processing stations of the apparatus, with the result that, in particular, even a reel change cannot have an adverse effect.

In order to achieve this object, the invention provides that, during the processing in at least one of the various stations, the web-like material is transported on a moving underlying surface and, at the same time, is retained on the underlying surface with the aid of negative pressure.

In principle, the material web remains intact for as long as possible and passes through one or more processing stations as a continuous material web which has not yet been subdivided into individual blanks. In order to ensure that the web is guided in a reliable and controlled manner and is transported without damage, it rests on at least one transporting belt rather than being drawn primarily over rollers. In each case one or more belts support the web over essentially a large surface area, suction air, which is produced beneath the belt or belts with the aid of negative pressure, fixing the web in a precise position. For this purpose, use is preferably made of suction boxes which are located beneath the belt or belts and are connected to the negative-pressure generator.

It is also already known in principle, from U.S. Pat. No. 3,288,037, for separate blanks consisting of paper to be transported through a side-folding station, during the production of envelopes, on a perforated belt and thus for the blank to be retained on the transporting belt with the aid of suction air and negative pressure. This document deals exclusively with the optimum handling of individual blanks and not with a continuous, not yet separated material web. The precisely positioned alignment and guidance of individual blanks is more complicated and difficult than the handling of a material web. For this reason, U.S. Pat. No. 3,288,037 is concerned only with blanks and not with material webs.

Essentially the same applies to what is said in EP 0 502 687 B1.

A development of the invention provides for the material, as a material web which has not yet been separated into blanks, to be provided with envelope windows before the web is fed to the side-folding station.

During the production of the envelope windows in particular, the fact that the transportation of the material web is stabilized by being supported over a large surface area and by the negative pressure has a positive effect. It is indeed the case that the cross section of the material web is weakened by the envelope windows, with the result that, in particular with large windows, there is the risk of the material web tearing. This also applies when a window blank has already been adhesively bonded to the borders of the window opening and the adhesive has not yet set. Both cases result in a reduction in the tensile strength of the web. With the aid of said process steps, however, the production of packaging bags and/or of envelopes may be further increased, and the reel change also results in fewer breakdowns than has been the case up until now.

Further features of the invention can be gathered from the subclaims in conjunction with the description and the drawing.

The invention is described in more detail hereinbelow with reference to the exemplary embodiment which is illustrated in the drawing, in which:

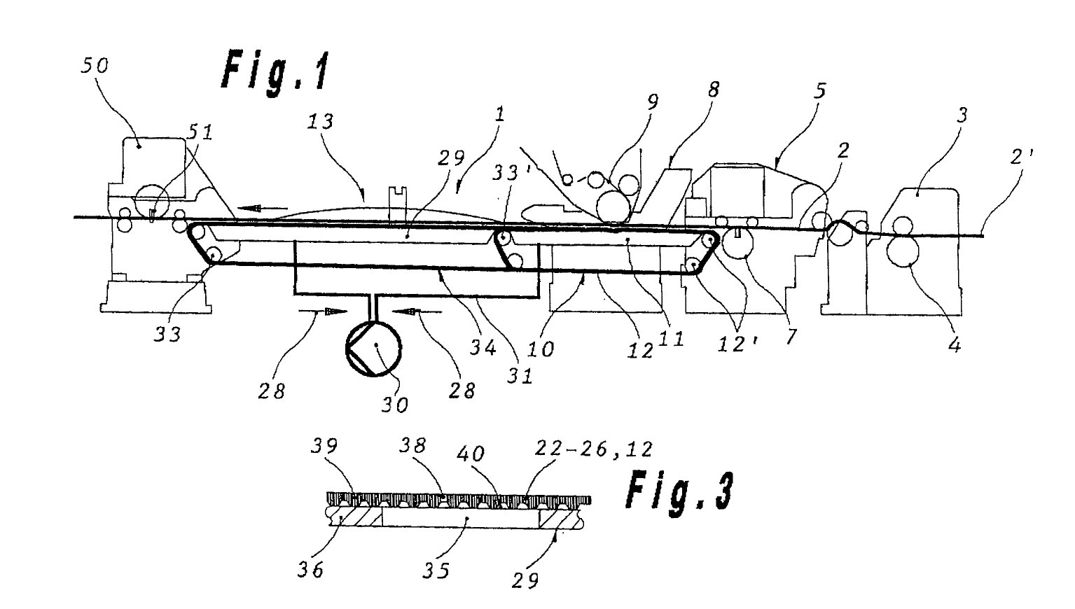

FIG. 1 shows a schematic diagram of the apparatus in side view;

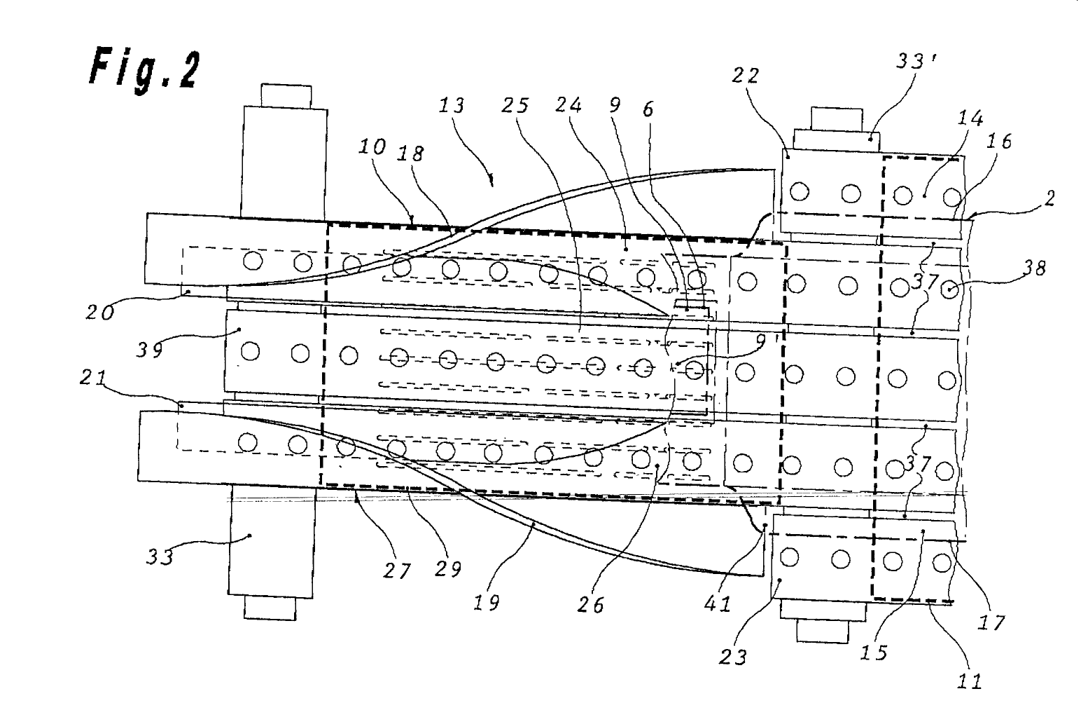

FIG. 2 shows, in the form of a schematic diagram and on an enlarged scale, a simplified plan view of essential features of the side-folding station; and

FIG. 3 is shows, in broken-away form in each case, a section through a transporting belt and a top plate which forms the top side of a suction box.

An apparatus 1 for producing packaging bags, envelopes and the like from web-like material 2′ comprises, according to FIG. 1, a plurality of stations in which the material 2′ is processed, which includes being cut to size, provided with preformed longitudinal and transverse creases and with adhesive, folded and, finally, finished off, it also being possible for the drying of not yet set adhesive to be covered here. Not all of the stations which are necessary for this purpose are illustrated in FIG. 1. A station 3, which is of no particular interest here, contains a pair of drawing rollers 4, with the aid of which the web-like material 2′ is drawn through stations which are arranged upstream of the station is, as seen in the transporting direction, and are not illustrated here.

According to the exemplary embodiment, a station 5 adjoins the station 3 and may be provided, for example, for producing window openings 6 in the material web 2. A cutting cylinder 7 serves directly for producing the window openings 6.

Located downstream of the station 5, as seen in the production direction, is a station 8 in which in each case one window blank 9 is adhesively bonded to the borders of each window opening 6.

The material web 2 is transported through the window-gluing station 8 with the aid of a suction-belt transporting device 10. This comprises at least one suction box 11 and one or more transporting belts 12 arranged one beside the other.

Each transporting belt 12 runs around deflecting rollers 12′, with the result that its top strand moves in each case along a suction-opening-containing top plate of the suction box 11. Instead of one suction box 11, it is also possible for a plurality of suction boxes to be arranged one beside the other and/or one behind the other.

The station 8 is adjoined in the production direction by a side-folding station 13. Here, in the lateral border region of the material web 2, side parts 14 and 15 which have already been cut to size are first of all moved continuously into an upright position from a planar position and then folded over. This is illustrated in FIG. 2 by way of the chain-dotted contour of the borders 16 and 17 of the material web 2. According to the exemplary embodiment, it is also possible for the borders 16 and 17 of the cut-to-size material web to overlap, if appropriate, in the folded-over state.

For moving each side part 14, 15 into an upright position and folding it over, the side-folding station 13 respectively has a folding element 18, 19 and in each case one folding blade 20, 21. The functioning and action of the folding elements 18 and 19 and of the folding blades 20 and 21 is known in principle and thus need not be explained in any more detail.

Expediently, the transporting belts 12 do not just serve for transporting the material web 2 through the window-gluing station 8 without stressing; according to the exemplary embodiment, they are also provided directly as tensile-stressing-free transport means for the material web 2 in the side-folding station 13. In the region of the side-folding station 13, the transporting belts 12 are constituted by outer transporting belts 22 and 23 and transporting belts 24, 25 and 26 arranged therebetween. The transporting belts 22 to 26 together form a moving underlying surface 27 which has a large surface area and on which the material web 2 is located as it is moved through the side-folding station 13. The interior web 2 is retained on the underlying surface 27 or on the transporting belts 22 to 26 with the aid of negative pressure 28 and/or suction air. The negative pressure (arrow 28) is generated with the aid of at least one suction-opening-containing suction box 29 and at least one negative-pressure generator 30. It is also the case that the suction box 11 belonging to the window-gluing station 8 is connected to the negative-pressure generator 30 via a line 31. In the region of the side-folding station 13, the transporting belts 22 to 26 run around deflecting rollers 33. They are driven at the web speed and, together with the suction box 29 and the negative-pressure generator 30, form a suction-belt transportinq device 34.

According to the exemplary embodiment illustrated in FIG. 1, the suction-belt transporting device 34 of the side-folding station receives a material web 2 which already has envelope windows 9′ (FIG. 2) and, if appropriate, preformed longitudinal and transverse creases and has been laterally cut to size in order to form the side parts 14, 15 of the envelopes.

The negative pressure prevailing in the suction box 29 acts on the material web 2 through openings 35 in a top plate 36 and draws it onto the transporting belts 22 to 26. The transporting belts 22 to 26 are spaced apart from one another in each case, with the result that slits 37 are located between them. Through said slits 37, the negative pressure acts directly on the material web 2. Instead of a plurality of “suction belts”, it is also possible to provide, in each transporting device 10 or 34, a single suction belt of sufficient width together with, if appropriate, a plurality of transporting belts without a suction function.

Furthermore, it is also possible for suction openings 38 to be provided directly in one or more or in all of the transporting belts 22 to 26.

The transporting belts are expediently toothed belts with teeth directed towards the top plate 36. By virtue of the teeth and also by virtue of the additional arrangement of the suction openings 38, it is possible for the negative pressure to be uniformly and specifically provided directly on the underside of the material web 2.

The deflecting rollers 33 for the transporting belts 22 to 26 are arranged such that in each case the top strand 39 (FIGS. 2 and 3) is located on the top side 40 of the suction box 29, having openings 35 or also slots.

It is also expedient if the respectively outer transporting belts 22 and 23 in the side-folding station terminate upstream, as seen in the transporting direction, of the transporting belts 24, 25 and 26, which are in the centre or arranged therebetween (FIG. 2). For this reason, additional deflecting rollers 33′ are provided for the respectively outer transporting belts 22 and 23. The position of the deflecting rollers is expediently selected such that they are located immediately upstream of the receiving ends 41 of the folding elements 18 and 19, as seen in the transporting direction.

Illustrated in FIG. 1 downstream of the side-folding station 13, as seen in the transporting direction, is a further station 50, in which, for example, a severing cut can be produced with the aid of a cutting device 51. This station and further stations which are not illustrated serve to complete the apparatus 1.

Finally, the invention is not restricted to the features which have been described and illustrated in the figures. Rather, modifications are also possible without departing from the basic idea of the invention. It is thus also possible, for example, to convey blanks for envelopes using a suction-belt transporting device of which the transporting belts 22 to 26 also have suction openings 38 in addition to being spaced apart from one another and thus forming slits 37. It is also possible for the deflecting rollers 33 of the outer transporting belts and/or those of the inner transporting belts to be provided at different locations.

1. Process for producing packaging bags, envelopes and the like from web-like material (2′ ), having a plurality of stations (3, 5 and 50) , including a side-folding station (13), in which the material (2′) is processed, which includes being cut to size, provided with preformed longitudinal and transverse creases and with adhesive, folded, and, finally, finished off, the drying of not yet set adhesive also being covered here, characterized in that, during the processing in at least one of the various stations, the web-like material is transported on a moving underlying surface and, at the same time, is retained on the underlying surface with the aid of negative pressure.

2. Process according to claim 1, characterized in that the material (2′) is fed to the side-folding station (13)′ as a laterally cut-to-size material web (2) provided with longitudinal and transverse grooves, and in that, during passage through the side-folding station (13), the material web (2) is located on a moving underlying surface (27) and is retained on the underlying surface (27) with the aid of negative pressure (28) as side parts (14, 15) for the packaging bags, envelopes and the like which are to be produced are moved into an upright position and folded over.

3. Process according to at least one of the preceding process claims, characterized in that the material web (2) is provided with envelope windows (9′) before it is fed to the side-folding station (13).

4. Process according to at least one of the preceding process claims, characterized in that use is made of transporting belts (22 to 26) as the underlying surface (27) and of at least one negative-pressure generator (30) and at least one suction box (26) in order to generate the negative pressure (28).

5. Process according to at least one of the preceding process claims, characterized in that the negative pressure (28) acts on the material web (2) through slits (37) between the transporting belts (22 to 26).

6. Process according to at least one of the preceding process claims, characterized in that the negative pressure (28) acts on the material web (2) through suction openings (38) in the transporting belts (22 to 26).

7. Apparatus for producing shipping bags, envelopes and the like from web-like material (2′), having a plurality of stations (3, 5 and 50), including a side-folding station (13), in which the material (2′) is processed, which includes being cut to size, provided with preformed longitudinal and transverse creases and with adhesive, folded, and, finally, is finished off, the drying of not yet set adhesive also being covered here, characterized in that at least one suction-belt transporting device (34) is provided for transporting a material web (2) through the side-folding station (13).

8. Apparatus according to claim 7, characterized in that a station (5) for producing window openings (6) and a station (8) for adhesively bonding window blanks (9) to the orders of the window openings (6) in the material web (2) are arranged upstream of the side-folding station (13), as seen in the production direction.

9. Apparatus according to at least one of the preceding apparatus claims, characterized in that a plurality of transporting belts (22 to 26) are provided in the side folding station (13) and are spaced apart laterally, in each case the top strand (39) being arranged on the top side (40) of at least one suction box (29) having openings (35) and/or slots,

10. Apparatus according to at least one of the preceding apparatus claims, characterized in that at least individual transporting belts (22 to 26) have suction openings (38).

11. Apparatus according to at least one of the preceding apparatus claims, characterized in that outer transporting belts (22, 23) terminate upstream, as seen in the transporting direction, of transporting belts (24, 25 and 26) arranged between them.

12. Apparatus according to at least one of the preceding apparatus claims, characterized in that, instead of the suction box, a plurality of suction boxes are arranged one beside the other and/or one behind the other.
